(19) United States
(12) Patent Application Publication
(10) Pub. No.: US 2009/0186729 A1
(43) Pub. Date: Jul. 23, 2009

(54) SILENT CHAIN

(75) Inventor: Takashi Tohara, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/333,493

(22) Filed: Dec. 12, 2008

(30) Foreign Application Priority Data
Jan. 17, 2008 (JP) 2008-008151

(51) Int. Cl. F16G 13/06

(52) U.S. Cl. 474/213

(57) ABSTRACT

In a silent chain, interleaved toothed link plates in guide rows and non-guide rows are articulably connected by connecting pins fixed to guide plates at the outer ends of the guide rows. In each guide row, the connecting pins are bent in such a way that the central portions of the connecting pins are closer to each other than the end portions when the chain is under moderate tension or no tension. As greater tension is applied to the chain, the bent connecting pins become substantially straight and are brought into substantially uniform contact with pin holes in the plates.

### CROSS REFERENCE TO RELATED APPLICATION

This application claims priority on the basis of Japanese patent application 2008-008151, filed Jan. 17, 2008. The disclosure of Japanese application 2008-008151 is hereby incorporated by reference.

### FIELD OF THE INVENTION

The invention relates to a silent chain of the kind used in a power transmission mechanism in an automobile engine, an industrial machine, a transfer mechanism or the like. The silent chain according to the invention can be used, for example, as a timing chain in an automobile engine, for transmitting power from a crankshaft sprocket to one or more valve-operating camshaft sprockets.

### BACKGROUND OF THE INVENTION

A typical silent chain is in the form of an endless loop and comprises alternating guide rows and non-guide rows of plates. Each of the guide rows comprises a pair of guide plates and a plurality of toothed link plates disposed between the guide plates. Each of the non-guide rows comprises a plurality of toothed link plates. Each toothed link plate has a pair of teeth and a pair of pin holes. The link plates of each non-guide row are interleaved with the plates of two adjacent guide rows, and articulably connected thereto by connecting pins extending through pin holes of the toothed link plates of the non guide-row and the toothed link plates of the two adjacent guide rows. The pins fit loosely in the pin holes of the toothed link plates, but are fixedly secured in pin holes in guide plates of said adjacent guide rows. A typical silent chain is described in U.S. Pat. No. 6,485,385.

FIG. 6 shows a portion of a conventional silent chain 11 under a relatively low tensile load. Toothed link plates 13 and 14, are respectively interleaved and arranged in alternating guide rows 15 and non-guide rows 16. Toothless guide plates 17 are arranged on both outermost ends of each guide row 15 and connected to each other by connecting pins 19, which extend through, and fit loosely in, pin holes 12 in the toothed link plates. The ends of the connecting pins 19 are securely fitted into pin holes 18 of the guide plates 17. The connecting pins 19 are round pins, i.e., pins having a uniform circular cross-section.

Since the toothed plates are interleaved, the total number of plates 14 in each of the non-guide rows 16 is n (for example, four) and the total number of the plates in the guide rows, including toothed plates 13 and guide plates 17, is n+1 (for example, five). Since the number of the plates in a guide row 15 is larger than the number of the plates in a non-guide row 16, the plates 13 and 17 in the guide rows 15 are typically made thinner than the plates 14 in the non-guide rows 16 in order balance the strengths of the guide rows and the non-guide rows.

When the conventional silent chain 11 is subjected to a high tensile load while transmitting power, connecting pins 19 are slightly bent as shown in FIG. 7. Each bent connecting pin 19 remains in contact with the inner circumferential surfaces of pin holes 12 of centrally located link plates 13a in a guide row 15, and also remains in contact with the inner circumferential surfaces of pin holes 12 of link plates 14a arranged on the outermost sides of a non-guide row 16. However, because the pin is bent, it is no longer firmly in contact with the inner circumferential surfaces of the pin holes in the outer toothed link plates of the guide rows and the innermost toothed link plates of the non-guide rows. Therefore, when tension is applied to the chain, high stress is applied to the centrally located plates 13a in the guide row 15, but only low stress is applied to the outer toothed plates 13. Likewise, very high stress is concentrated in the outer plates 14a of the non-guide rows while low stress is applied to the centrally located plates 14. As a result, since the loads applied to the plates are different, good stress balance is not maintained.

Because a very high stress is concentrated in plates 14a on the outermost sides of the non-guide rows 16, when the silent chain is flexed as it engages or disengages a sprocket, that high surface pressure applied to the mutually engaging surfaces of the connecting pins and the pin holes in these plates 14a causes excessive wear, resulting in wear elongation, possible rupture of one or more of the plates in the vicinity of the pin holes, and possible rupture of the connecting pins.

To solve the above-described problem, the outermost toothed link plates 14a in the non-guide row 16 can be made thicker than the other plates 14 in the non-guide row. However, increasing the thickness of plates 14a will increase the overall mass of the silent chain, and also increase the number of different parts needed to assemble the chain, making manufacture of the chain more difficult and expensive. Furthermore, when the conventional silent chain, having thicker plates 14a, is used as an engine timing chain, engine fuel efficiency will deteriorate, and noise will be generated in the operation of the engine increases. Thus, these measures to address problems in conventional chains can generate adverse environmental effects, especially when used in a high output engine.

Objects of this invention include solving the above-mentioned problems and providing a silent chain in which, even when the connecting pins are flexed as a result of a high tensile load, the connecting pins are in substantially uniform contact with the inner peripheral surfaces of the pin holes in all the toothed link plates of each row. The objects of the invention include improvement of the stress balance in the link plates, prevention of reduction in the strength of a silent chain, suppression of wear at the locations of contact between pin holes of the link plates and the connecting pins, and suppression of wear elongation of the chain.

### SUMMARY OF THE INVENTION

When the condition of a failed conventional silent chain used as a timing chain was checked, it was found that some connecting pins were bent in directions corresponding to the directions of the excessive tensile force, and areas of rupture were found in as many as 90% or more of the outermost plates in the non-guide rows. In addition measurements of abrasion wear showed the wear of the pin holes in the outermost plates of the non-guide rows was significantly greater than the wear found in the pin holes of the other plates.

We have determined that, if the connecting pin comes into uniform contact with the inner peripheral surfaces of the pin holes of all the toothed link plates when the connecting pin is bent as a result of a high tensile load applied to the chain, the load applied to all the toothed link plates can be equalized, and local wear, chain wear elongation, and rupture of the pin holes and the connecting pins can be suppressed.

The silent chain according to the invention comprises alternating guide rows and non-guide rows of plates. Each of the guide rows comprises a pair of guide plates and a plurality of toothed link plates disposed between the guide plates. Each of the non-guide rows comprises a plurality of toothed link plates. Each of the toothed link plates has a pair of teeth and a pair of pin holes. The link plates of each non-guide row are interleaved with the plates of two adjacent guide rows, and articulably connected thereto by connecting pins extending through pin holes of the toothed link plates of the non guide-row and the toothed link plates of the two adjacent guide rows. The pins are fixedly secured in pin holes in guide plates of said adjacent guide rows. Each of the connecting pins has opposite ends and a circular cross-section. The chain is characterized by the fact that the two connecting pins in each guide row are bent, when relaxed, so that portions thereof located midway between their ends are closer together than their ends.

The above-described bent configuration of the connecting pins equalizes the surface pressures acting between the connecting pins and the inner circumferential surfaces of the pin holes in the toothed link plates. Equalization of surface pressures prevents rupture of individual link plates. Equalization of surface pressures also suppresses wear of the inner circumferential surfaces of the pin holes and of the connecting pins, and thereby reduces wear elongation of the chain, and suppresses noises generated as a result wear elongation.

Preferably, the toothed link plates in each guide row through which each connecting pin extends are aligned with one another, and the pin holes of the toothed link plates in each non-guide row through which the same connecting pin extends are also aligned with one another. Thus, when tension is applied to the chain, the connecting pins can be substantially straightened and brought into uniform contact with the pin holes of the toothed link plates of the guide rows and into uniform contact with the pin holes of the toothed link plates of the non-guide rows. When a high tensile load is applied to the chain, the loads applied to the individual toothed link plates are equalized and the stress balance of the toothed link plates is improved.

In the preferred embodiment, all the pin holes of the toothed link plates in the guide rows have the same inside diameter, and all the pin holes of said toothed link plates in the non-guide rows have the same inside diameter. Thus, the toothed link plates of the guide rows can be made according to a unified standard, and the toothed link plates of the non-guide rows can also be made according to a unified standard. As the result, the manufacture of the silent chain can be simplified.

### BRIEF DESCRIPTION OF THE DRAWINGS

FIG. 1 is a plan view of a part of a silent chain according to the invention;

FIG. 2 is side elevational view, partly in cross-section, showing a part of the silent chain;

FIG. 3(a) is a side elevational view of an inner plate of the chain;

FIG. 3(b) is a side elevational view of a guide plate of the chain;

FIG. 4 is a schematic cross-sectional view of a portion of the silent chain according to the invention, taken on a section plane parallel to the axes of the connecting pins of the chain, showing the chain under a low tensile load;

FIG. 5 is a similar schematic cross-sectional view showing the same portion of the silent chain of FIG. 4 under a high tensile load;

FIG. 6 is a schematic cross-sectional view of a portion of a conventional silent chain, taken on a section plane parallel to the axes of the connecting pins of the chain, showing the chain under a low tensile load; and

FIG. 7 is a similar schematic cross-sectional view showing the same portion of the silent chain of FIG. 6 under a high tensile load.

### DETAILED DESCRIPTION OF THE PREFERRED EMBODIMENTS

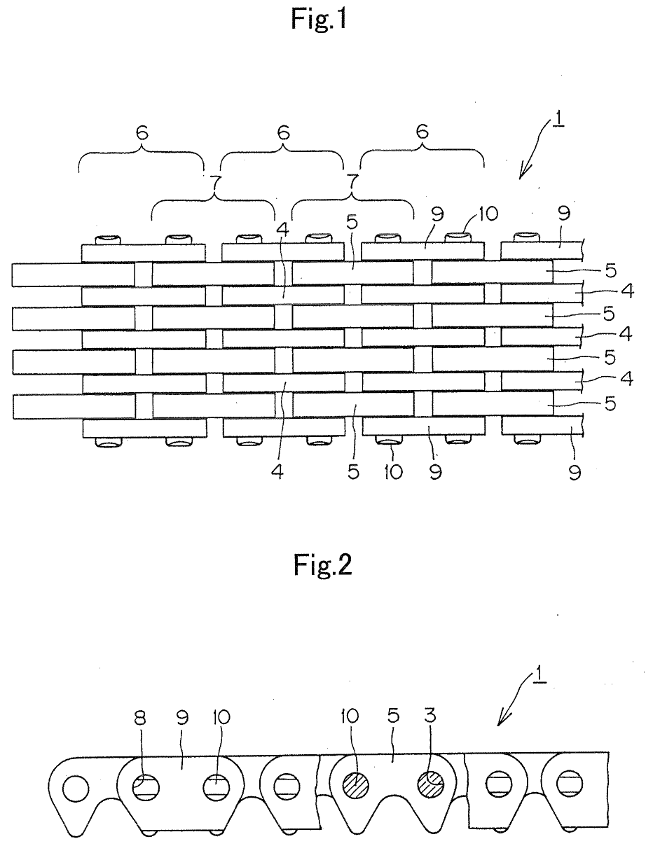

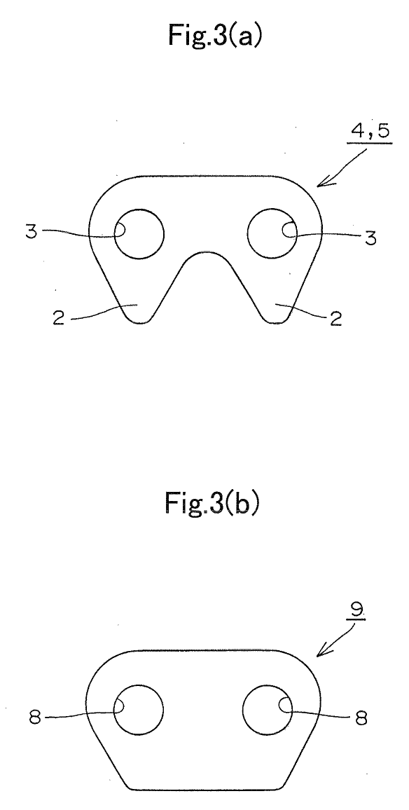

As shown in FIGS. 1 and 2, an endless silent chain 1 according to the invention comprises interleaved inner plates 4 and 5, and guide plates 9. As shown in FIG. 3(a), each of the inner plates is formed with a pair of teeth 2, and a pair of pin holes 3. The inner plates 4 are arranged in guide rows 6 between a pair of guide plates 9 on the outermost sides of the chain. Inner plates 5, which form the non-guide rows 7 of the chain, are interleaved with the plates 4 and 9. Connecting pins 10 are press-fit into pin holes 8 of the guide plates 9. These connecting pins fit loosely in pin holes 3 of the inner plates 4 and 5.

In the silent chain 1, the number of plates in a guide row 6 (three toothed link plates 4 and two guide plates 9, for a total of five) is larger than the number (four) of the plates in a non-guide row 7, as in a conventional silent chain. To balance the strengths of the guide rows 6 and the non-guide rows 7, the plates 4 and 9 in the guide rows 6 are made thinner than the plates 5 in the non-guide rows 7. The numbers of plates can, of course, be varied, but generally, in the case of a silent chain in which the plates are interleaved individually, the number of plates in a guide row will exceed the number of plates in a non-guide row by one plate.

The toothed plates 4 in the guide rows 6 and the plates 5 in the non-guide rows 7 preferably have the same profile. As shown in FIG. 3(a), each such plate has a pair of teeth 2 and a pair of pin holes 3. The inside diameters of the pin holes 3 in the toothed guide row plates 4 are all preferably the same size, as are the inside diameters of the pin holes 3 in the non-guide row plates. Preferably, as shown in FIG. 3(a), the pin holes in plates 4 and the pin holes in plates 5 have the same diameter. The guide plates 9, are arranged at regular intervals along the sides of the chain at both ends of each guide row and secured to the connecting pins 10, prevent the chain from sliding laterally off a sprocket. As shown in FIG. 3(b), these guide plates have no teeth, but have pin holes 8 into which the connecting pins 10 are press-fit.

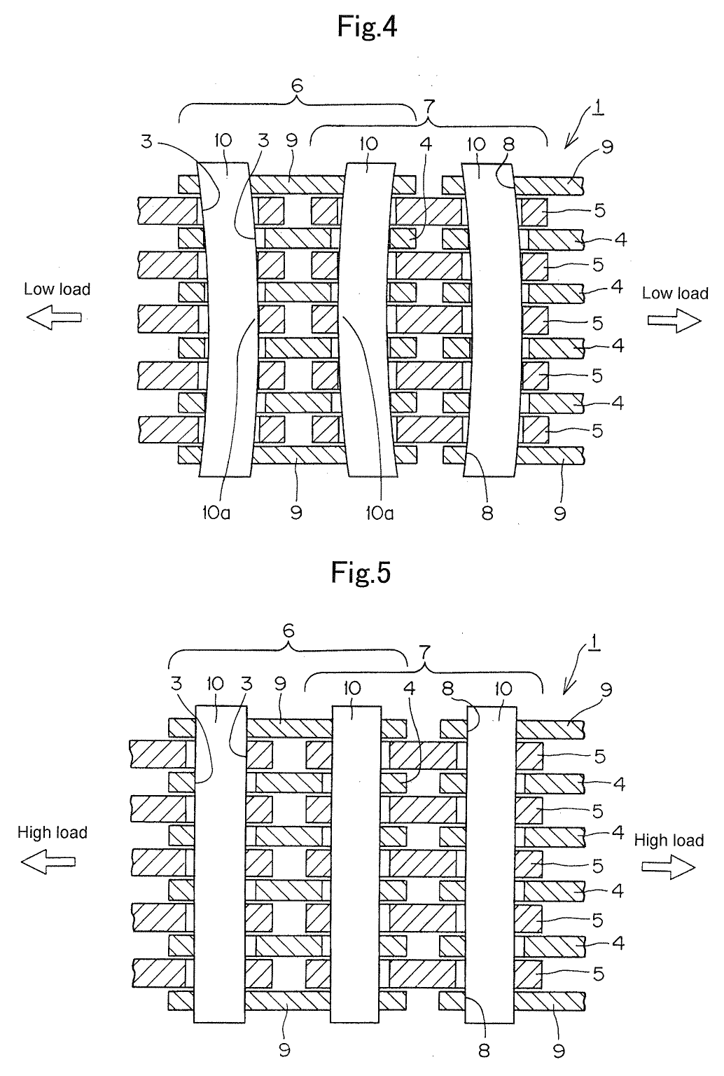

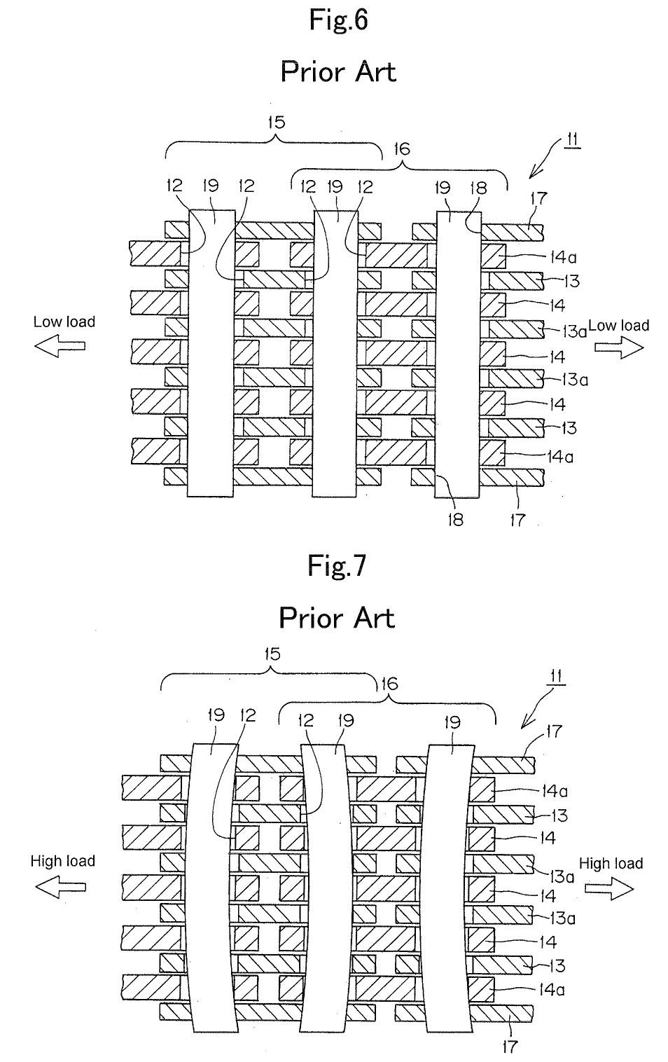

The connecting pins 10 are round pins, i.e., pins having a uniform circular cross-section. As shown in FIG. 4, these pins are slightly bent when the chain is under no tensile load or under a moderate tensile load. Two connecting pins 10 extend from the guide plate 9 at one end of a guide row to a corresponding guide plate 9 at the opposite end of the same guide row. End portions of the two connecting pins extending through the plates in a guide row are fixedly secured in pin holes 8 of the guide plates 9 at the ends of the guide row, and are slightly bent so that their central portions 10a, midway between their ends are closer together than their ends. Because the pins are fixed to the guide plates, the intermediate portions of two pins connected to the opposite guide plates in any given guide row always tend to bend toward each other. The pins are preferably smoothly curved and the radius of curvature of their bend is preferably such that when a high tensile load is applied to the chain, that is, a tensile load approximating the usual tensile load encountered during an ordinary power transmitting operation of the chain, the pins become substantially straight as shown in FIG. 5.

Because the connecting pins 10 are straightened as shown in FIG. 5 when a high tensile load is applied to the chain, they more uniformly contact the inner peripheral surfaces of the pin holes 3 in the respective toothed plates 4 and 5 in the guide rows 6 and the non-guide rows 7, respectively. That is, the contact pressures between a connecting pin and the inner peripheral surfaces of the pin holes of the plates in any given row through which that pin extends become substantially uniform when the pins become straight. Therefore, wear of the pin holes 3 and the connecting pins 10 can be suppressed, and at the same time rupture of the non-guide row plates 5, which is likely to occur in a conventional chain can be prevented. Accordingly, wear elongation and generation of noised due to wear elongation can be prevented. Furthermore, since equalized loads are applied to the respective toothed plates 4 and 5, the stress balance of the plates 4 and 5 is improved, and reduction of the strength of the silent chain can be prevented.

Furthermore, where the sizes of pin holes 3 in the plates 4 and 5 are the same and the profiles of the plates 4 and 5 are also the same, and only their thicknesses are different, the guide row plates 4 can be made according to a unified standard, and the non-guide row plates 5 can also be made according to a unified standard. As the result, the manufacture of the silent chain can be simplified.

What is claimed is:

1. A silent chain comprising alternating guide rows and non-guide rows of plates, each of the guide rows comprising a pair of guide plates and a plurality of toothed link plates disposed between the guide plates, and each of the non-guide rows comprising a plurality of toothed link plates, each said toothed link plate having a pair of teeth and a pair of pin holes, wherein the link plates of each non-guide row are interleaved with the plates of two adjacent guide rows and articulably connected thereto by connecting pins extending through pin holes of the toothed link plates of said non guide-row and the toothed link plates of said adjacent guide rows, said pins being fixedly secured in pin holes in guide plates of said adjacent guide rows, each of said connecting pins having opposite ends and having a circular cross-section, and the connecting pins in each guide row being bent, when relaxed, so that portions thereof located midway between their ends are closer together than said ends.

2. A silent chain according to claim 1, in which the pin holes of the toothed link plates in each guide row through which each connecting pin extends are aligned with one another, in which the pin holes of the toothed link plates in each non-guide row through which the same connecting pin extends are also aligned with one another, whereby, when tension is applied to the chain, said connecting pins can be substantially straightened and brought into uniform contact with the pin holes of the toothed link plates of the guide rows and into uniform contact with the pin holes of the toothed link plates of the non-guide rows.

3. A silent chain according to claim 1, in which all the pin holes of said toothed link plates in the guide rows have the same inside diameter, and all the pin holes of said toothed link plates in the non-guide rows have the same inside diameter.

4. A silent chain according to claim 3, in which the pin holes of the toothed link plates in each guide row through which each connecting pin extends are aligned with one another, in which the pin holes of the toothed link plates in each non-guide row through which the same connecting pin extends are also aligned with one another, whereby, when tension is applied to the chain, said connecting pins can be substantially straightened and brought into uniform contact with the pin holes of the toothed link plates of the guide rows and into uniform contact with the pin holes of the toothed link plates of the non-guide rows.
